(19) United States
(12) Patent Application Publication
(10) Pub. No.: US 2023/0299363 A1
(43) Pub. Date: Sep. 21, 2023

(54) DEVICE FOR PRODUCING AN ENERGY STORE

(71) Applicant: Blackstone Technology Holding AG, Baar (CH)

(72) Inventor: Ulrich ERNST, Geroldswil (CH)

(73) Assignee: Blackstone Technology Holding AG, Baar (CH)

(21) Appl. No.: 18/007,893

(22) PCT Filed: Jun. 3, 2021
(86) PCT No.: PCT/EP2021/064956

§ 371 Date: Dec. 2, 2022

(30) Foreign Application Priority Data
Jun. 3, 2020 (CH) 00661/20

(51) Int. Cl. H01M 10/0585; H01M 4/04

(52) U.S. Cl. CPC H01M 10/0585; H01M 4/0414; H01M 4/0416

(57) ABSTRACT

A device for producing an energy store comprises a plurality of modules, the modules comprising a first electrode module, a second electrode module and a stack module. The energy store comprises a cell, the cell containing a first electrode, a second electrode and a separating layer, wherein the separating layer is arranged between the first electrode and the second electrode. The first electrode module comprises a first screen printing device for producing the first electrode and the second electrode module comprises a second screen printing device for producing the second electrode.

### BACKGROUND

The present invention relates to a device for producing an energy store, in particular by means of a screen printing process.

### PRIOR ART

In the following, the structure and the production method for an energy store that contains an electrochemical cell will be described as an example.

An electrochemical cell comprises a cathode, i.e., a positive electrode, an anode, i.e., a negative electrode, a separator which separates the positive electrode from the negative electrode, and a housing which contains the positive electrode, the negative electrode, the separator and an electrolyte, in which the said positive electrode, the negative electrode and the separator are at least partially accommodated. The anode and cathode can form a circuit with a consumer via contacts.

An electrochemical cell can be used for a primary battery or a secondary battery. A primary battery is referred to below as a battery that is not rechargeable, i.e., that is intended for single use. In the following, a battery that is rechargeable is referred to as a secondary battery: the term accumulator is often also used for this type of energy store.

Secondary batteries have been used in a wide variety of applications for decades, and a wide variety of materials can be used for their electrochemical cells. The uses for secondary batteries are increasing, for example, they are found in portable electronic devices, medical devices, transportation, as a backup power generator, as a storage device to compensate for fluctuations in electricity supply, as a storage system for renewable energy.

In particular for portable electronic devices or medical devices that are used on or in the body, the size and the weight of these energy stores play an important role in addition to the costs.

For safety reasons, lithium-ion cells often contain a graphite anode. However, the capacity of a lithium-ion cell with a graphite anode is limited, therefore it has been proposed, e.g., in document WO2018/005038 A1, providing an alkali metal with a low melting point as the anode instead of graphite.

However, the metal melt, for example a lithium melt, must be cleaned before it is used, and a filter is used for this purpose. The filtered lithium metal can then be deposited onto an collector or separator using an additive manufacturing process.

In order that the cathode and anode do not come into direct electrical contact with one another, a separator is provided between each cathode and each anode. According to a variant of the method, one of the electrodes can be inserted into a separator pocket. The separator is designed as a sheet-like, microporous separating element which is permeable for the electrolyte, electrons or ions, but not to the particles of the corresponding positive or negative paste-like active mass.

Cathodes, separators and anodes are bundled into a cell stack that forms the primary cell. The cell stack usually contains 6 cathodes, 6 anodes that are arranged alternately to one another, and the corresponding number of separators that are located between two adjacent cathodes and anodes. In a subsequent method step, the cathodes are connected to one another in an electrically conductive manner, so that when an electrical voltage is applied, a current can flow to the cathodes or can flow away from the cathodes. In the same way, the anodes are connected to one another in an electrically conductive manner, so that when an electrical voltage is applied, a current can flow to the anodes or can flow away from the anodes.

An accumulator contains a plurality of cell stacks. The cell stacks are placed in a plastic housing configured to hold the electrolyte. Adjacent cell stacks are separated from one another by housing partitions. The contacts of the cathodes and anodes of adjacent cell stacks are usually connected to one another by means of a welding process. The housing is then closed with a lid. The lid contains openings for the positive and negative contact poles as well as openings for feeding the liquid electrolyte. The contact poles are cast on after the lid has been installed. The lid is usually not removable, which is why the electrolyte is supplied to each cell stack through the openings provided for this purpose, which are also closed after filling is complete. An initial charging cycle (formation) can only be carried out in this state. After the charging cycle is complete, the accumulator is ready for use.

The manufacturing process described is very complicated in practice, since it comprises a large number of process steps, some of which take place discontinuously, for example the drying of the active mass, which takes place in drying cabinets and can take up to 48 hours. As a result, the turnaround time required to manufacture such an accumulator could still be a few days.

Therefore, for example, in FR2690567 A1, a method for producing an electrochemical store or a supercapacitor was developed, which includes an electrochemical cell arranged in a housing, which includes a first collector, a first electrode, a separator, a second electrode and a second collector. The electrodes and the separator are produced using a screen-printed ink. The screen printing ink consists of an ion-conductive polymer, a salt dissolved and dissociated in the polymer, a highly volatile solvent in which the polymer and the salt are soluble. This screen-printing ink also contains the active mass and an electron conductor used to produce the electrodes, the proportion by weight of which is between 0 and 30% of the active mass. The first and second collectors and the housing are also produced using the screen printing process.

The ion-conductive polymer may include a linear or crosslinked polymer. The salt content can be between 0.1 and 2 mol/l of the polymer. The solvent can contain an element from the group of propylene carbonates, butylene carbonates, terpineols, glycols, their derivatives, and mixtures thereof. The electronic conductor may comprise a metallic or carbon-containing compound. The mass fraction of the active material and the electronic conductor can comprise 20% to 80% of the screen printing ink. The active mass can include carbon, metal oxides and conductive polymers. The active mass for the cathode can contain lithium. In addition to carbon, the active mass for the anode can contain oxides, sulfides, selenides, phosphosulfides, oxyhalides and conductive polymers.

However, only an energy store with a surface of 20×20 mm to 30×30 mm was produced with the previously known method.

### OBJECT OF THE INVENTION

It is therefore an object of the invention to improve an energy store produced by means of a screen printing method, comprising a housing, a first and second electrode and a separating layer arranged between these electrodes, for example a separator or electrolyte, in such a way that a plurality of energy stores can be produced simultaneously with consistent quality.

### SUMMARY OF THE INVENTION

The object is achieved in particular by a device according to claim 1. Advantageous variants are the subject of claims 2 to 10.

When the term “for example” is used in the following description, this term refers to exemplary embodiments and/or variants, which is not necessarily to be construed as a more preferred application of the teachings of the invention. Similarly, the terms “preferably”, “preferred” should be understood as referring to one example from a set of exemplary embodiments and/or variants, which should not necessarily be construed as a preferred application of the teachings of the invention. Accordingly, the terms “for example,” “preferably,” or “preferred” may refer to a plurality of exemplary embodiments and/or variants.

The following detailed description contains various exemplary embodiments of the device according to the invention and the method according to the invention. The description of a particular device or method is to be considered as exemplary only. In the specification and claims, the terms “include”, “comprise”, “have” are interpreted as “including but not limited to”.

A device for producing an energy store comprises a plurality of modules for producing a cell of the energy store. The modules include a first electrode module, a second electrode module, and a stack module. The cell includes a first collector, a first electrode, a second electrode, a second collector, and a separating layer. The separating layer is arranged between the first electrode and the second electrode, the first collector being arranged on a side of the first electrode opposite the separating layer, the second collector being arranged on a side of the second electrode opposite the separating layer. The first electrode module comprises a first screen printing device for producing the first electrode and the second electrode module comprises a second screen printing device for producing the second electrode.

According to an embodiment, the first screen printing device includes a first printing pad and a first printing screen, which has a first frame that contains a first lattice structure for receiving a first paste. A paste is understood to be a flowable mass, for example a slurry. A first application device is configured to apply the first paste to the first lattice structure. If necessary, the first paste is distributed on the first lattice structure by means of a first distribution device belonging to the device. The first lattice structure has recesses or openings which can be filled with the first paste. A first extraction element is provided for extracting the first paste from the openings or recesses of the first lattice structure onto the first printing pad. After extraction of the first paste with the frame, the lattice structure can be separated from the paste and the first paste remains on the first printing pad.

In particular, the first electrode is obtainable by drying the first paste in a first drying unit.

According to an embodiment, the second screen printing device comprises a second printing pad and a second printing screen, which has a second frame that contains a second lattice structure for receiving a second paste. In particular, a second application device can be configured to apply the second paste onto the second lattice structure. If necessary, the second paste can be distributed on the second lattice structure by means of a second distribution device belonging to the device, wherein the second lattice structure has recesses or openings which can be filled with the second paste. A second extraction element can be provided for extracting the second paste from the openings or recesses of the second lattice structure onto the second printing pad. After extraction of the second paste, the second lattice structure can be separable from the second paste with the frame and the second paste can remain on the second printing pad.

According to an embodiment, the second electrode can be obtained by drying the second paste in a second drying unit. In particular, the first paste can differ from the second paste.

According to an embodiment, the device includes a third screen printing device for producing the separating layer. In particular, the third screen printing device can comprise a third printing pad and a third printing screen, which has a third frame that contains a third lattice structure for receiving a third paste, wherein at least the third lattice structure can be filled with the third paste in order to form the separating layer, wherein the third paste is applied by a third application device onto the third lattice structure, the third paste being distributed on the third lattice structure by means of the third distribution device belonging to the device. The third lattice structure can have recesses or openings which can be filled with the third paste. A third extraction element can be provided for extracting the third paste from the openings or recesses of the third lattice structure onto the third printing pad. After extraction of the third paste with the third frame, the third lattice structure can be separable from the third paste and the third paste can remain on the third printing pad. In particular, the separating layer can be obtainable by drying the third paste in a third drying unit.

In particular, the third screen printing device can comprise a third printing pad and a third printing screen, which has a third frame that contains a third lattice structure for receiving a third paste, wherein at least the third lattice structure can be filled with the third paste in order to form the separating layer, wherein the third paste is applied to the third lattice structure via a third application device, wherein the third paste is distributed on the third lattice structure by means of the third distribution device belonging to the device. The third lattice structure can have recesses or openings which can be filled with the third paste. A third extraction element can be provided for extracting the third paste from the openings or recesses of the third lattice structure onto the third printing pad. After extraction of the third paste with the third frame, the third lattice structure can be separable from the third paste and the third paste can remain on the third printing pad. In particular, the separating layer can be obtainable by drying the third paste in a third drying unit.

According to an embodiment, at least one of the first electrodes or the second electrodes can consist of multiple layers. In particular, according to an embodiment, the first electrode can have a thickness of 1 μm up to and including 300 μm. For example, the first electrode can have a thickness of 10 μm up to and including 300 μm. It is also possible to produce first electrodes with a thickness in the range of 1 μm to 10 μm for foil or film-like energy stores by means of screen printing processes. In particular, according to an embodiment, the second electrode can have a thickness of 1 μm up to and including 300 μm. For example, the second electrode can have a thickness of 10 μm up to and including 300 μm. It is also possible to produce second electrodes with a thickness in the range of 1 μm to 10 μm for foil or film-like energy stores by means of screen printing processes.

In particular, according to an embodiment, the separating layer can have a thickness of 1 μm up to and including 50 μm. In particular, according to an embodiment, the first collector can have a thickness of 1 μm up to and including 50 μm. In particular, according to an embodiment, the second collector can have a thickness of 1 μm up to and including 50 μm. It is also possible to produce separating layers with a thickness in the range of 1 μm to 10 μm for foil or film-like energy store by means of screen printing processes.

In particular, according to an embodiment, the first collector can consist of aluminum or an aluminum compound. According to this exemplary embodiment, the first collector is configured as a positive collector. In particular, according to an embodiment, the second collector can consist of copper or a copper compound. According to this exemplary embodiment, the second collector is configured as a negative collector.

In particular, according to an embodiment, the first paste of the first electrode can have a mass fraction of active mass of 50% up to and including 90%, with the remaining mass fraction comprising a binding material and/or a solvent and/or a conductive additive.

In particular, according to an exemplary embodiment, the second paste of the second electrode can have a mass fraction of active mass of 50% up to and including 90%, with the remaining mass fraction comprising a binding material and a conductive additive.

In particular, according to an embodiment, the separating layer can consist of two cover layers made of polypropylene and an intermediate layer made of polyethylene arranged between the two cover layers. According to this exemplary embodiment, the thickness of the separating layer can in particular amount to 38 μm. According to an embodiment, the separating layer contains a mixture of particles of inorganic substances in a matrix material and a microporous polyolefin, which is suitable for preventing an ion flow from the anode to the cathode.

The particles of inorganic substances can contain at least one element from the group consisting of SiO₂, Al₂O₃, CaCO₃, TiO₂, SiS₂, SiPO₄. The matrix material can contain at least one element from the group consisting of polyethylene oxide, polyvinylidene fluoride (PVDF), N-methyl-2-pyrrolidone (NMP), carboxymethyl cellulose (CMC), polytetrafluoroethylene (PTFE), polyurethane (PU), polyacrylonitrile (PAN), polymethyl methacrylate (PMMA) or polytetraethylene glycol diacrylate. The microporous polyolefin may comprise a polyolefin membrane, such as a polyethylene membrane. The separating layer may have a porosity ranging from 20% to 80%.

In particular, according to an embodiment, the separating layer can contain an electrolyte which consists of 50 mol % LiPF₆ and 50 mol % a mixture of ethylene carbonate (EC) and diethyl carbonate (DEC).

According to an embodiment, a cell can include a first electrode that is configured as a cathode. In particular, the cathode contains lithium cobalt oxide. For example, an organic based electrolyte may contain lithium phosphate in a mixture of ethylene carbonate and dimethyl carbonate. A preferred electrolyte consists of 1 mol/dm³ LiPF₆ in 1:1 (vol %) EC (ethylene carbonate)/DMC (dimethyl carbonate). A second electrode can be configured as an anode. In particular, the anode can contain lithium titanate.

According to a further embodiment, the cathode can contain lithium cobalt oxide. An electrolyte based on an aqueous gel can be used, for example LiNO₃ in H₂O and polyvinylpyrrolidone, optionally with the addition of silicon dioxide. According to this embodiment, the anode can contain lithium manganese oxide (LiMn₂O₄).

According to a further embodiment, the cathode can contain lithium cobalt oxide. If appropriate, carbon can be added, in particular containing carbon nanotubes. A polylactic acid based electrolyte can be used.

According to a further exemplary embodiment, a LiNiMnCoO₂ electrode can be used, referred to below as an NMC electrode. The NMC electrode is provided as a paste to be processable in the screen printing process. For this purpose, NMC is mixed with a binder. In particular, polyvinylidene fluoride (PVDF), N-methyl-2-pyrrolidone (NMP) or carboxymethylcellulose (CMC) or a surfactant can be used as a binder, in particular a nonionic surfactant, for example an alcohol alkoxylate, for example isopropanol or 2-[4-(2,4,4-trimethylpentan-2-yl)phenoxy]ethanol.

According to an embodiment, a cathode can be used that contains lithium iron phosphate (LiFePO₄) and is referred to below as an LFP electrode. In powder form, LFP can be mixed with a conductive additive and mixed with water and a binder whereby a shear thinning paste is obtainable, that can be processed by a screen printing method. PVDF, NMP or CMC, for example, can be used as a binder. Alternatively, or in addition, an emulsion containing a fluorinated polyacrylate emulsion can be used.

According to an embodiment, an anode containing graphite can be used. A paste containing graphite for the production of an anode in the screen printing method can contain a styrene-butadiene rubber (SBR) as a binder.

In order to be able to process a paste for a cathode, an anode or a separating layer or separator layer by means of a screen printing method, it is advantageous if the paste has pseudoplastic properties, i.e., the viscosity of the paste decreases with increasing shearing forces. When shearing forces are applied to the paste, for example when the paste is applied to a screen of a screen printing device, its viscosity decreases, thereby making screen printing easier.

When shearing forces act on the paste, its viscosity corresponds to the dynamic viscosity. The dynamic viscosity advantageously amounts to not more than 100 Pas, in particular not more than 75 Pas, particularly preferably not more than 60 Pas. After the screen printing method is completed, the viscosity increases to static viscosity because the influence of the shearing forces is removed. For example, the static viscosity of the corresponding paste at rest can amount to more than 150 Pas. For example, the static viscosity can range from 150 to 1000 Pas. The static viscosity of the paste can be further increased by a subsequent drying process. In addition, the paste can be compressed, for example, by calendering or rolling.

According to a further embodiment, a solid electrolyte can be used. A solid electrolyte can contain borane anions. A borane can include at least one compound from the group consisting of boron hydrides or boranes, boron chlorides, boron fluorides, boron bromides or boric iodides.

In particular, according to an embodiment, the energy store can contain a plurality of cells that form at least one cell stack. In particular, according to an embodiment, the plurality of cells can be arranged in a parallel connection or in a series connection. When connected in series connection, an operating voltage of at least 12 V may be available.

In particular, according to an embodiment, the cell stack comprises at least a first and a second cell, wherein an intermediate layer is arranged between the first and second cell, wherein the intermediate layer separates the collector for the first electrode of the first cell from the collector for the second electrode of the second cell, so that a total voltage between the first collector and the second collector results from the sum of the cell voltages of the first and second cell. In particular, according to an embodiment, the intermediate layer can be electrically conductive, so that a flow of current or flow of ions can take place from the first cell into the second cell.

In particular, according to an embodiment, the cell may contain an electrolyte. In particular, according to an embodiment, the electrolyte can be contained in the first or second paste or the separating layer.

In particular, according to an embodiment, the first or second electrode and the separating layer can be stacked in the cell such that the separating layer is arranged above the first electrode and the second electrode is arranged above the separating layer. According to this embodiment, the separating layer lies on the first electrode.

In particular, according to an embodiment, the first or second electrode or the separating layer can contain a porous material.

In particular, according to an embodiment, the first or second collector can at least partially be configured as a housing. In particular, according to an embodiment, the first or second collector can at least partially be configured as a cooling element. According to an embodiment, the energy store includes one or more cells and the first and second collectors. For example, an aluminum foil or a nickel foil can be used as a collector.

In particular, according to an embodiment, a plurality of corresponding first or second electrodes or separators for a plurality of cells can be arranged side by side on the first printing pad or the second printing pad or the third printing pad.

The cell can be enclosed in a housing. Such a housing can preferably contain a plastic material that is resistant to all substances used for the first and second electrodes, the separating layer, and an electrolyte. A housing can be manufactured using an additive manufacturing process. The housing can be configured as a screen printed housing as will be described below. For example, the housing can contain one of the plastic materials mentioned below.

A rechargeable battery according to one of the preceding embodiments comprises a housing, a first collector, a first electrode, a separating layer, a second electrode, a second collector. The housing includes a housing element, wherein the housing element includes an element from the group consisting of a housing base, a housing lid and at least one housing side element. The first collector is arranged on the housing base. The first electrode is arranged on the first collector. The separating layer is arranged on the first electrode. The second electrode is arranged on the separating layer. The second collector is arranged on the second electrode. The housing lid is arranged on the second collector. At least the first electrode is configured as a screen-printed electrode, the separating layer is configured as a screen-printed separating layer and the second electrode is configured as a second screen-printed electrode. The first collector is positioned adjacent to the housing base and positioned partially within a housing side element. The second collector is arranged adjacently to the housing lid and is partially disposed within a housing side element.

In particular, at least one of the first or second electrodes contains a plurality of screen-printed electrode sub-layers. One of the first or second electrodes may include a first screen-printed electrode sub-layer that differs in composition from a second screen-printed electrode sub-layer. At least one of the first and second collectors may include a screen-printed collector layer. The housing can include at least one screen-printed housing element. The housing may contain a liquid electrolyte or at least the separating layer can contain a solid electrolyte.

A method for producing an energy store is described below, wherein the energy store comprises a cell, a first collector, a first electrode, a second electrode, a second collector and a separating layer, the separating layer being arranged between the first electrode and the second electrode, wherein the first electrode is produced by means of a first screen printing device and the second electrode is produced by means of a second screen printing device. The first electrode is placed on a first collector, the separating layer is applied on the first electrode. The second electrode is applied on the separating layer and the second collector is placed on the second electrode.

In particular, the first collector is arranged on a side of the first electrode opposite to the separating layer, and the second collector is arranged on a side of the second electrode opposite to the separating layer. According to an embodiment, the separating layer is produced by means of a third screen printing device. According to an embodiment, the first collector is produced by means of a first collector screen printing device. According to an embodiment, the second collector is produced by means of a second collector screen printing device.

According to an embodiment, a first electrode module is provided, which contains the first screen printing device, optionally a first drying unit and a first stacking device, by means of which the first electrode is screen printed, optionally dried, and placed on the first collector.

According to an embodiment, a second electrode module is provided, which contains the second screen printing device, optionally a second drying unit and a second stacking device, by means of which the second electrode is screen printed, optionally dried, and placed on the separating layer. Drying can take place by supplying heat, by means of UV or in a vacuum.

According to an embodiment, a separating layer module is provided which contains the third screen printing device, optionally a third drying unit and a third stacking device, by means of which the separating layer is screen printed, optionally dried, and placed on the first electrode.

According to an embodiment, a first collector module is provided, which contains the first collector screen printing device, optionally a first collector drying unit and a first collector stacking device, by means of which the first collector is screen-printed, optionally dried and placed on a housing element.

According to an embodiment, a second collector module is provided, which contains the second collector screen printing device, optionally a second collector drying unit and a second collector stacking device, by means of which the second collector is screen-printed, optionally dried and placed on the second electrode.

According to an embodiment, a housing element module is provided which contains a housing element screen printing device, by means of which at least one housing element is screen printed. In particular, the housing element module can contain a housing element drying device. In particular, the housing element module can contain a housing element stacking device.

According to an embodiment, at least one of the first electrodes, the second electrodes or the separating layers can be compressed after drying. The compression can take place, for example, by means of calendering or rolling.

According to an embodiment, the first screen printing device can include a first printing pad and a first printing screen, which has a first frame that contains a first lattice structure for receiving a first paste, wherein the first paste is applied to the first lattice structure with a first application device. If necessary, the first paste can be distributed on the first lattice structure by means of a first distribution device belonging to the first screening device, wherein the first lattice structure has recesses or openings which are filled with the first paste. The first paste can be removed from the openings or recesses of the first lattice structure by means of a first extraction element and applied on the first printing pad, wherein lattice structure is separated from the paste after extraction of the first paste with the frame and the first paste remains on the first printing pad.

According to an embodiment, the first electrode can be obtained by drying the first paste in a first drying unit.

According to an embodiment, the second screen printing device can comprise a second printing pad and a second printing screen, which has a second frame that contains a second lattice structure for receiving a second paste, wherein the second paste is applied to the second lattice structure with a second application device, and if necessary, the second paste can be distributed on the second lattice structure by means of a second distribution device belonging to the second screen printing device, wherein the second lattice structure has recesses or openings which are filled with the second paste, wherein the second paste is extracted from the openings or recesses of the second lattice structure by a second extraction element, and is applied to the second printing pad, wherein the second lattice structure is separated after extraction of the second paste with the second frame from the second paste and the second paste remains on the second printing pad.

According to an embodiment, the second electrode can be obtained by drying the second paste in a second drying unit. In particular, the first paste can differ from the second paste.

According to an embodiment, the separating layer can be produced by means of a third screen printing device. According to an embodiment, the third screen printing device can comprise a third printing pad and a third printing screen, which has a third frame that contains a third lattice structure for receiving a third paste, wherein at least the third lattice structure is filled with the third paste to form the separating layer. According to an embodiment, the third paste can be applied to the third lattice structure by means of a third application device. According to an embodiment, the third paste can be distributed on the third lattice structure by means of the third distribution device belonging to the device. According to an embodiment, the third lattice structure can have recesses or openings that are filled with the third paste. According to an embodiment, the third paste can be removed from the openings or recesses in the third lattice structure by means of a third extraction element and applied to the third printing pad. According to an embodiment, the third lattice structure can be separated from the third paste with the third frame after extraction of the third paste and the third paste can remain on the third printing pad.

According to an embodiment, a plurality of lattice structures is filled with different pastes in order to form at least one first and one second electrode, which are separated from one another by a separating layer.

Without being limited to any particular configuration, the first electrode can be configured as a cathode and the second electrode can be configured as an anode. Of course, the method can be used in the same way if the first electrode is configured as an anode and the second electrode is configured as a cathode. According to an embodiment, an energy store can thus comprise a cell, wherein the cell contains a first, positive collector, a cathode, an anode, a second, negative collector and a separating layer, wherein the separating layer is arranged between the cathode and the anode, wherein the first collector is arranged on a side of the anode opposite the separating layer, wherein the second collector is arranged on a side of the cathode opposite the separating layer. The cathode is produced using a cathode screen printing device, the anode is produced using an anode screen printing device.

According to an embodiment, the anode or the cathode can comprise a plurality of layers which are produced by means of the corresponding anode screen printing device or cathode screen printing device.

According to an embodiment, a plurality of anodes or cathodes can be produced simultaneously with the corresponding anode screen printing device or cathode screen printing device.

According to an embodiment, the first or second electrode and the separating layer can be stacked.

According to an embodiment, an intermediate layer can be provided when the production of the cell or the cell stack has been completed.

According to an embodiment, a plurality of corresponding first or second electrodes or separating layers for a plurality of cells can be arranged next to one another on the first printing pad or the second printing pad or the third printing pad.

According to an embodiment, the first electrodes, second electrodes and separating layers can be separated from one another after drying in the corresponding first, second or third drying unit.

According to an embodiment, the first or second electrode is dried or hardened in a drying plant or hardening plant after it has left the first or second screen printing device, before the first electrode is placed on the printing pad or the second electrode is placed on the first separating layer. According to an embodiment, the second electrode is dried or hardened in a second drying plant or hardening plant, then the second electrode is placed on the first separating layer. A second separating layer is then placed on the second electrode if the cell or the cell stack is not yet complete.

Alternatively or additionally, according to an embodiment, an enclosure can be provided when the production of the cell has been completed. The enclosure can comprise a plastic layer. The enclosure can be part of a plastic housing which accommodates the cell or a plurality of cells, i.e., the cell stack. According to an embodiment, the cell stack thus includes a plurality of cells. The enclosure can include a cooling element.

According to an embodiment, the cell contains an electrolyte. The electrolyte can comprise a solid, liquid or gas. According to an embodiment, the electrolyte is contained in the first or second paste.

According to an embodiment, the cell stack is laid or placed in a housing, wherein the housing subsequently is filled with an electrolyte which at least partially surrounds the cells.

The housing can then be closed with a housing lid so that, for example, a fluid electrolyte can be prevented from leaking out. In particular, the housing can be configured as a plastic housing.

According to an embodiment, the separating layer or the separating layers are configured in such a way that they enable an exchange of electrons or ions via the electrolyte between the first and second electrodes but prevent a current flow from the first electrode to the second electrode. According to an embodiment, the separating layer contains a material containing pores. According to an embodiment, the separating layer contains a porous material. The separating layer can be produced in a sintering process, for example. According to an embodiment, the separating layer contains a plurality of passages which contain the electrolyte and allow transport of ions or electrons from the first to the second electrode or vice versa.

According to an embodiment, each of the first or second collectors has a contact end that is connected to all of the first or second collectors of each cell of the cell stack that belong to electrodes with the same polarity.

According to an embodiment, a housing element, which is configured as a housing layer, is provided when the production of the cell or the cell stack is complete. According to an embodiment, the housing layer is configured as a housing wall. According to an embodiment, the cell or the cell stack is accommodated in a housing. According to an embodiment, the cell or the cell stack is arranged between a first fluid-tight housing layer and a second fluid-tight housing layer. According to an embodiment, the first fluid-tight housing layer is positioned on the printing pad and the first electrode is arranged on the first fluid-tight housing layer.

According to an embodiment, a plurality of first electrodes for a plurality of cells or cell stacks are arranged next to one another on the first printing pad. According to an embodiment, a plurality of second electrodes for a plurality of cells or cell stacks are arranged next to one another on the second printing pad. In particular, a plurality of first and second electrodes for a plurality of cells or cell stacks can be printed next to one another on the printing pad.

According to an embodiment, the first electrodes are separated from one another after drying in the drying unit. According to an embodiment, the second electrodes are separated from one another after drying in the drying unit. A separating device can be provided for this purpose, for example a punching device or a cutting device. The first electrodes separated in this way can be arranged in a housing. The first electrodes located in the housing can be separated from the second electrodes by a separating layer. The first and second electrodes and the separating layer can be at least partially enclosed by an electrolyte which is already contained in the first or second electrodes or the separating layer or is added to a cell after assembly. Alternatively, the electrolyte can be added after the cells or cell stacks have been placed in the housing.

According to an embodiment, the cells or cell stacks are separated from one another after completion. A separating device can be provided for this purpose, for example a punching device or a cutting device. The cells or cell stacks separated in this way can be arranged in a housing. The cells or cell stacks located in the housing can be at least partially enclosed by an electrolyte, which is filled into the housing after the cells or cell stacks have been arranged in the housing.

According to an embodiment, the lattice structure or the paste can contain a metal or a metal ion. According to an embodiment, the metal or metal ion can be in the form of particles of a powder. The metal or metal ion can include an element from the group consisting of Al, Au, Ag, Ba, Bi, Ca, Ce, Cd, Co, Cr, Cu, Er, Fe, Hf, Ga, Gd, In, K, La, Li, Na, Nb, Nd, Ni, Mo, Mn, Mg, Pb, Pr, Pt, Sc, Sn, Re, Rh, Ru, Ta, Te, Th, Ti, V, W, Y, Yb, Zn, Zr. A particle can contain a plurality of metals or metal ions, in particular the particle can contain an alloy or an ion lattice. According to an embodiment, the particle may contain a core and a shell, where the metal of the core may differ from the metal of the shell. According to an embodiment, the powder can comprise particles which contain an intermetallic compound.

According to an embodiment, the lattice structure or the paste can comprise a mixture of at least two elements from the group consisting of plastics, ceramics, and metals. According to an embodiment, the paste can consist of particles, wherein the particles comprise a mixture of at least two elements from the group consisting of plastics, ceramics, and metals.

According to an embodiment, the paste used for the first electrode, the second electrode or the separating layer may contain a solid electrolyte. Such a solid electrolyte can contain a salt, in particular a superionic conducting salt, for example a boron salt. According to an embodiment, at least one salt of a polyborate is used, for example a salt containing at least one of a (B₁₀H₁₀)²⁻ or (B₁₂H₁₂)²⁻ anion. For example, a sodium hydroborane Na₂(B₁₀H₁₀), Na₂(B₁₂H₁₂) or Na₄(B₁₂H₁₂)(B₁₀H₁₀) can be used.

According to an embodiment, the paste can contain coated particles. For example, a particle containing a plastic or a ceramic can be coated with a metal. The plastic can contain an element of the plastic materials described above or below.

The proportion of metal in the mixture can be 0.01-10% by weight in order to achieve a notable effect. A concentration of 0.05-5% by weight has proven particularly advantageous.

The invention therefore consists in mixing plastic, metal, and ceramic pastes, which have advantageous properties for the desired application, with a binder in a suitable manner in so to be suitable for processing in the screen printing process.

Such mixtures can be processed, for example, in stirred tanks, ultrasonic homogenizers, high-pressure homogenizers, in tubes containing dynamic mixers or static mixers.

The comminution takes place in grinding devices suitable for this purpose, such as ball mills, agitator ball mills, circulation mills (agitator ball mills with a pin grinding system), disc mills, annular chamber mills, double-cone mills, three-roll mills, and batch mills. The grinding devices can be equipped with grinding chambers with cooling devices for dissipating the thermal energy introduced during the grinding process.

The comminution preferably takes place with the addition of the majority, in particular at least 80% to 100%, of the carrier medium. The time required for the comminution depends in a manner known per se on the desired degree of fineness of the particles, respectively on the particle size of the particles. For example, a milling time in the range from 30 minutes up to and including to 72 hours has proven useful, although a longer period of time is also conceivable.

Pressure and temperature conditions during comminution are generally not critical, for example normal pressure has proven to be suitable. For example, temperatures in the range from 10° C. up to and including 100° C. have proven to be suitable.

The content of the electron or ion donors contained in the paste is preferably at least 10% by weight, particularly preferably at least 20% by weight, based on the total weight of the preparation.

The content of reactive metal or reactive ions in the active composition is preferably at least 50% by weight, particularly preferably at least 70% by weight, based on the proportion of electron or ion donors in the paste.

Ceramic pastes can, for example, comprise powders containing aluminum, for example aluminum oxide Al₂O₃ or aluminum nitride AlN. Various oxides or non-oxidative compounds such as carbides, nitrides or borides can also be used. A ceramic powder can contain an element from the group consisting of ZrO₂, TiO₂, TiC, TiB, TiB₂, TiN, MgO, SiC, SiO₂, Si₃N₄, BN, B₄C, WC. The ceramic powder can comprise a mixture of at least two of the aforementioned components.

The paste can contain a carrier medium as the coherent phase, which is solid or flowable under standard conditions. The carrier medium can comprise a ceramic or a plastic. The carrier medium is therefore in particular not liquid. Esters of alkyl and aryl carboxylic acids, hydrogenated esters of aryl carboxylic acids, polyhydric alcohols, ether alcohols, polyether polyols, ethers, saturated acyclic and cyclic hydrocarbons, mineral oils, mineral oil derivatives, silicone oils, aprotic polar solvents and mixtures are used as the carrier medium.

According to an embodiment, the separating layer or the paste contains graphite, in particular graphene.

According to an embodiment, the separating layer or paste contains a plastic. The plastic can in particular comprise polymer compositions which contain a polymer component or consist of a polymer component which is preferably selected from the group of polyolefins, polyolefin copolymers, polytetrafluoroethylene, ethylene-tetrafluoroethylene copolymers, polyvinyl chloride, polyvinylidene chloride, polyvinyl alcohol, polyvinyl ester, polyvinyl alkanal, polyvinyl ketal, polyamide, polyimides, polycarbonates, polycarbonate blends, polyesters, polyester blends, poly(meth)acrylates, poly(meth)acrylate-styrene copolymer blends, poly(meth)acrylate-polyvinylidene difluoride blends, polyurethanes, polystyrenes, styrene copolymers, polyethers, polyether ketones and polysulfones and mixtures thereof.

According to an embodiment, the separating layer or a plastic used in the paste contains at least one polyurethane or consists of at least one polyurethane. The polyurethane is preferably at least one polyether polyurethane, particularly preferably at least one polytetrahydrofuran polyether urethane. Thermoplastic polyether polyurethanes are preferred.

According to an embodiment, the separating layer or a plastic used in the paste contains polyolefins which contain at least one polymerized monomer selected from ethylene, propylene, but-1-ene, isobutylene, 4-methyl-1-pentene, butadiene, and isoprene mixtures of them, monomers (such as vinyl aromatics) as comonomers. For example, polymers can be used which are built up from olefins without further functionality, such as polyethylene, polypropylene, polybutene-1 or polyisobutylene, poly-4-methylpent-1-ene, polyisoprene, polybutadiene, polymers of cycloolefins, for example cyclopentene, and copolymers of mono
or diolefins such as polyvinylcyclohexane.

According to an embodiment, low-density polyethylene homopolymers (LDPE) and polypropylene homopolymers and polypropylene copolymers can be used.

A polyethylene (PE) homopolymer can contain an element from the following group, the group consisting of the group elements PE-ULD (ULD=ultra-low density), PE-VLD (VPL=very low density), PE-LD (LD=low density), PE-LLD (LLD=linear low density), PE-MD (MD=middle density), PE-HD (HD=high density), PE-HD-HMW (HMW=high molecular weight), PE-HD-UHMW (UHMW=ultra-high molecular weight).

The polyethylene (PE) homopolymers can be classified according to their density. PE-ULD or PE-VLD have a density below 0.905 g/cm³.

PE-LD has a density of 0.915 to 0.935 g/cm³. LDPE can be obtained, for example, from a high-pressure process (ICI) at 1000 to 3000 bars and 150 to 300° C. with oxygen or peroxides as catalysts in autoclaves or tubular reactors. The crystallinity can be 40 to 50%, the average molar mass up to 600,000 g/mol. PE-LD can be highly branched, with branches having different chain lengths.

PE-LLD is available with metal complex catalysts in the low-pressure process from the gas phase, from a solution (e.g., gasoline), in a suspension or with a modified high-pressure process. PE-LLD is slightly branched with unbranched side chains, molar masses are higher than LDPE. PE-LLD has a density between 0.92 and 0.93 g/cm3.

PE-MD has a density between 0.93 and 0.94 g/cm³.

PE-HD has a density of 0.942 to 0.965 g/cm³. PE-HD is available in the medium-pressure (Phillips) and low-pressure (Ziegler) process. In the Phillips process, pressures of 30 to 40 bar and temperatures of 85 to 180° C. are used. Usually, chromium oxide is used as a catalyst. The molar masses are around 50,000 g/mol.

In the Ziegler process, pressures of 1 to 50 bar and temperatures of 20 to 150° C. are used. Aluminum alkyls, titanium halides and titanium esters are used as catalysts. The molar masses are in the range from about 200,000 to 400,000 g/mol. The production of PE-HD according to the Ziegler process can take place in suspension, in solution or in the gas phase. PE-HD is usually very weakly branched and has a crystallinity of 60 to 80%.

PE-HD-HMW can be obtained using the Ziegler process, Phillips process or a gas phase process. PE-HD-HMW has a density of more than 0.965 g/cm³.

PE-HD-UHMW (UHMW=ultra-high molecular weight) can be obtained using the Ziegler process with a modified Ziegler catalyst. The molar mass is in the range from 3,000,000 to 6,000,000 g/mol. PE-HD-HMW has a density of more than 0.97 g/cm³.

According to an embodiment, the separating layer or a plastic used in the paste can contain polypropylene. The term polypropylene should be understood below to mean both homo- and copolymers of propylene. Copolymers of propylene contain minor amounts of monomers that can be copolymerized with propylene, for example C2-C8-1-alkenes such as, e.g., ethylene, but-1-ene, pent-1-ene or hex-1-ene. Two or more different comonomers can also be used.

Suitable polypropylenes generally have a melt flow rate (MFR), according to ISO 1133, from 0.1 up to and including 200 g/10 min, in particular from 0.2 up to and including 100 g/10 min, at 230° C. and a weight of 2.16 kg.

According to an embodiment, the separating layer or a plastic used in the paste contains a halogen-containing polymer. Halogen-containing polymers include polytetrafluoroethylene homo- and copolymers, polychloroprene, chlorinated and fluorinated rubbers, chlorinated and brominated copolymer of isobutylene-isoprene (halogen rubber), chlorinated and sulfochlorinated polyethylene, copolymers of ethylene and chlorinated ethylene and chlorinated ethylene, epichlorohydrin compound copolymers, especially polymers, of halogen-containing vinyl compounds, e.g., polyvinyl chloride (PVC), polyvinylidene chloride (PVDC), polyvinyl fluoride, polyvinylidene fluoride and copolymers thereof, such as vinyl chloride-vinylidene chloride copolymers, vinyl chloride-vinyl acetate copolymers, vinylidene chloride copolymers or vinyl acetate copolymers. Polyvinyl chloride is used with different levels of plasticizers, with a plasticizer content of 0 to 12% of hard PVC, more than 12% as soft PVC or with a very high plasticizer content as PVC paste. Usual plasticizers are, e.g., phthalates, epoxides, adipic acid esters.

Polyvinyl chloride is produced by radical polymerization of vinyl chloride in bulk, suspension, microsuspension and emulsion polymerization. The polymerization is often initiated by peroxides.

Polyvinylidene chloride is produced by free-radical polymerization of vinylidene chloride. Vinylidene chloride can also be copolymerized with (meth)acrylates, vinyl chloride or acrylonitrile.

According to one embodiment, the separating layer or a plastic used in the paste contains a polyester. Polyesters are condensation products of one or more polyols and one or more polycarboxylic acids. In linear polyesters, the polyol is a diol and the polycarboxylic acid is a dicarboxylic acid. The diol component can be selected from ethylene glycol, 1,4-cyclohexanedimethanol, 1,2-propanediol, 1,3-propanediol, 1,4-butanediol, 2,2-dimethyl-1,3-propanediol, 1,6-hexanediol, 1, 2-cyclohexanediol, 1,4-cyclohexanediol, 1,2-cyclohexane dimethanol and 1,3-cyclohexane dimethanol. Also suitable are diols whose alkylene chain is interrupted once or several times by non-adjacent oxygen atoms. These include diethylene glycol, triethylene glycol, dipropylene glycol, tripropylene glycol and the like. Typically, the diol will contain 2 to 18 carbon atoms, preferably 2 to 8 carbon atoms. Cycloaliphatic diols can be used in the form of their cis or trans isomers or as a mixture of isomers. The acid component can be an aliphatic, alicyclic, or aromatic dicarboxylic acid. The acid component of linear polyesters is typically selected from terephthalic acids, isophthalic acids, 1,4-cyclohexanedicarboxylic acid, 1,3-cyclohexanedicarboxylic acids, succinic acids, glutaric acids, adipic acids, sebacic acids, 1,12-dodecanedioic acid, 2,6-naphthalenedicarboxylic acid and mixtures thereof.

According to an embodiment, the separating layer or a plastic used in the paste contains polyalkylene terephthalates, for example polyethylene terephthalates (PET), which can be obtained by condensing terephthalic acid with diethylene glycol. PET can also be obtained by transesterification of dimethyl terephthalate with ethylene glycol, with elimination of methanol to form bis(2-hydroxyethyl) terephthalate and its polycondensation, with liberation of ethylene glycol. Other preferred polyesters are polybutylene terephthalates (PBT), which can be obtained by condensation of terephthalic acid with 1,4-butanediol, polyalkylene naphthalates (PAN), such as polyethylene-2,6-naphthalate (PEN), poly-1,4-cyclohexanedimethylene terephthalate (PCT), and copolyesters of polyethylene terephthalate with cyclohexanedimethanol (PDCT), copolyesters of polybutylene terephthalate with cyclohexanedimethanol. PET and PBT have a high resistance as thermoplastic materials.

According to an embodiment, the separating layer or a plastic used in the paste contains a polycarbonate or a polyester carbonate. Polycarbonates result, e.g., from condensation of phosgene or carbonic acid esters such as diphenyl carbonate or dimethyl carbonate with dihydroxy compounds.

According to an embodiment, the separating layer or a plastic used in the paste contains a polyamide (PA for short) or co-polyamides, which have amide groups in the polymer main chain as essential structural elements. Polyamides can be produced, for example, by polycondensation from diamines and dicarboxylic acids or their derivatives. Polyamides can optionally be prepared with an elastomer as a modifier. Suitable co-polyamides are, for example, block copolymers of the above-mentioned polyamides with polyolefins, olefin copolymers, ionomers or chemically bonded or grafted elastomers; or with polyethers, for example with polyethylene glycol, polypropylene glycol or polytetramethylene glycol; and polyamides or copolyamides modified with EPDM or ABS.

According to an embodiment, the separating layer or a plastic used in the paste contains a polymer composition, the polymer being a polymer blend. The term “polymer blend” means a mixture of two or more polymers or copolymers. Polymer blends are used to improve the properties of the base component.

The method can be used particularly advantageously if a plurality of cells is to be generated simultaneously. A printing pad can have dimensions of up to 60 cm×60 cm.

The lattice structure can have any shape. In particular, the lattice structure can have an L-shaped form or have a rectangular surface. The thickness of the lattice structure can be in the range of 4 up to and including 200 micrometers, which means that energy stores for portable devices, sensors and the like can be produced with the method.

If a curing method is to be used to treat the paste in the lattice structure, a curing method that is optimal for the material combination used can be selected. A curing method according to one embodiment may expose the paste to temperatures in excess of 50° C. For example, such a curing method can be used when solvents have to be evaporated, for example oil-based or water-based solvents. A curing method according to an embodiment may expose the paste to temperatures below 0° C. A curing method according to an embodiment may include a sintering method. A curing method according to an embodiment may include the use of UV light sources.

### BRIEF DESCRIPTION OF THE DRAWINGS

The device according to the invention is illustrated below in a few exemplary embodiments. It is shown in:

FIG. 1 a view of a cell of an energy store according to a first embodiment,

FIG. 2 a screen printing device for producing a first electrode of an energy store according to FIG. 1,

FIG. 3 a screen printing device for producing a second electrode of an energy store according to FIG. 1,

FIG. 4 a screen printing device for producing a separating layer of an energy store according to FIG. 1.

FIG. 5 a view of an energy store according to a second embodiment,

FIG. 6 a schematic illustration of a device for producing an energy store,

FIG. 7a view of an energy store according to a third embodiment,

FIG. 7b an exploded view of the individual layers of the energy store shown in FIG. 7a,

FIG. 8a view of an energy store according to a fourth embodiment,

FIG. 8b an exploded view of the individual layers of the energy store shown in FIG. 8a,

FIG. 9 a view of an energy store module,

FIG. 10 a schematic view of an accumulator containing an energy store module according to a first embodiment,

FIG. 11 a schematic view of an accumulator containing an energy store module according to a second embodiment,

FIG. 12 a schematic view of an accumulator containing a plurality of energy store modules according to a third embodiment.

### DETAILED DESCRIPTION OF THE DRAWINGS

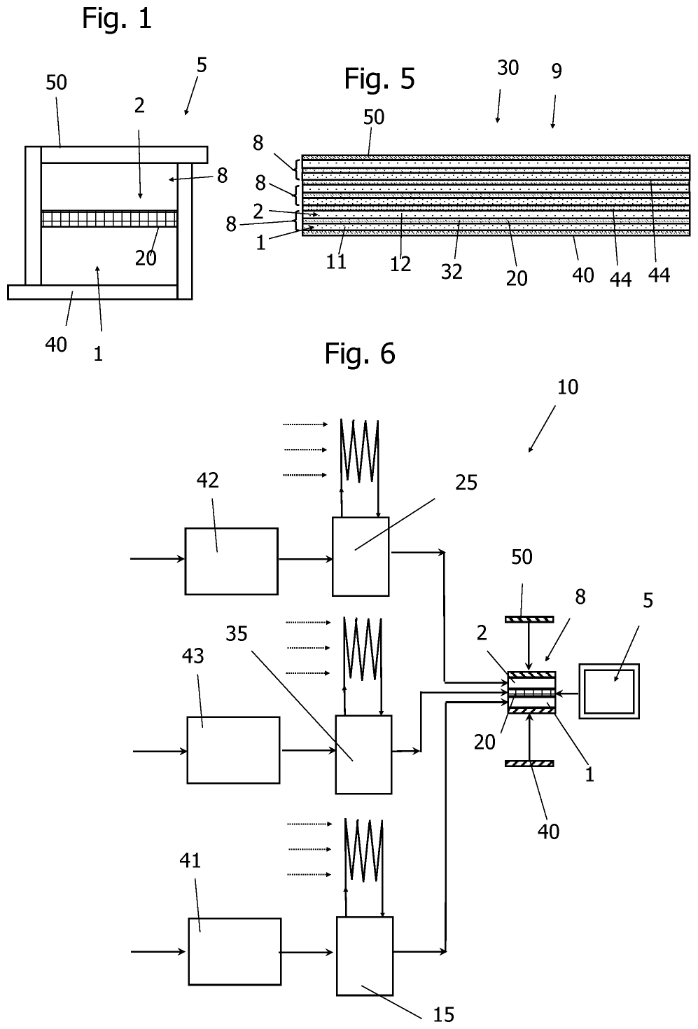

FIG. 1 shows an energy store 5 containing a cell 8 according to a first embodiment. The cell 8 comprises a first electrode 1 and a second electrode 2. A separating layer 20 is arranged between the first electrode 1 and the second electrode 2. The first electrode 1 comprises a first collector 40. The second electrode 2 comprises a second collector 50.

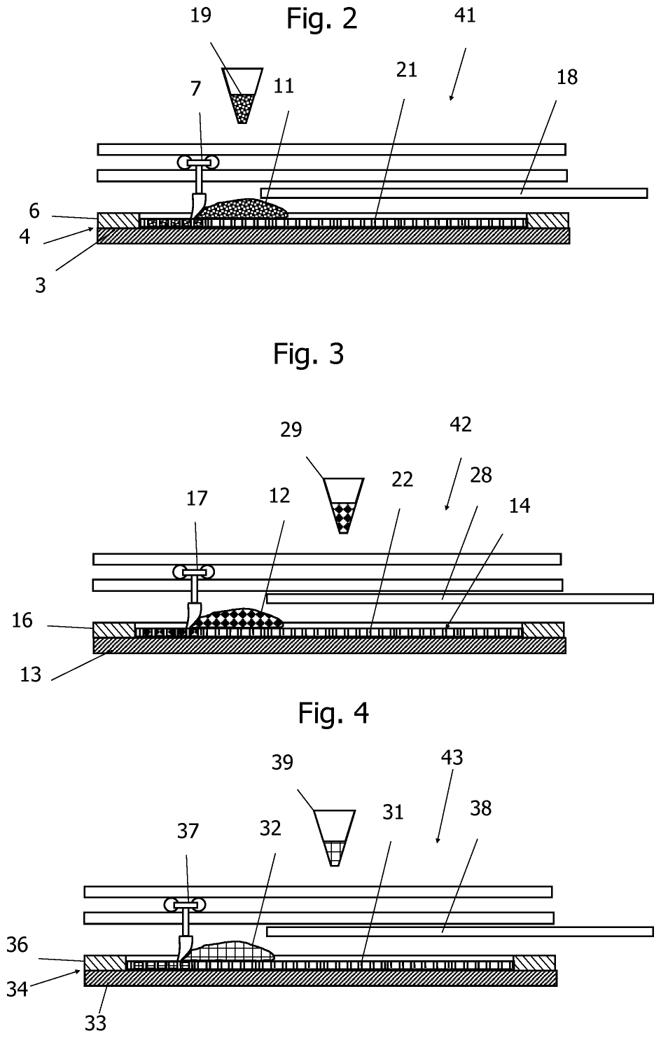

FIG. 2 shows a first screen printing device, which represents an embodiment of a first electrode module for producing a first electrode 1 of an energy store 5 according to FIG. 1. The screen printing device for producing an energy store 5 comprises a first printing pad 3, wherein the first printing pad 3 is configured for applying a first paste 11 for producing a first electrode 1 (see FIG. 1) of the energy store 5. The first screen printing device comprises a first printing screen 4 which has a first frame 6 which contains a first lattice structure 21 for receiving a first paste 11 for the first electrode 1 of the energy store 5. The first paste 11 can be distributed on the first lattice structure 21 by means of a first distribution device 7 belonging to the first screen printing device, and recesses or openings in the first lattice structure 21 can be filled with the first paste 11.

FIG. 3 shows a second screen printing device for producing a second electrode 2 of an energy store 5 according to FIG. 1. The second screen printing device comprises a second application device 29 containing a second paste 12. The second frame 16 is configured to accommodate a second lattice structure 22, wherein the second paste 12 is configured to be applied to the second lattice structure 22 for the second electrode 2 by means of the second application device 29. The second distribution device 17 is configured to distribute the second paste 12 on the second lattice structure 22 on the second printing pad 13. Recesses or openings in the second lattice structure 22 are configured to be filled with the second paste 12.

FIG. 4 shows a third screen printing device for producing a separating layer 20 of an energy store 5 according to FIG. 1. The third screen printing device comprises a third application device 39 containing a third paste 32.

The third frame 36 is configured to accommodate a third lattice structure 31, wherein the third paste 32 has been applied to the third lattice structure 31 for the separating layer 20 by means of the third application device 39. The distribution device 37 is configured to distribute the third paste 32 on the third lattice structure 31 on the third printing pad 33. Recesses or openings in the third lattice structure 31 can be filled with the third paste 32.

FIG. 5 shows a view of an energy store module 30 according to a second embodiment. The energy store module 30 contains a cell stack 9 which includes a plurality of cells 8 and a first collector 40 and a second collector 50. The first and second collector 40, 50 are connected to an electrical circuit, not shown, which contains at least one consumer. The cell stack 9 shown in FIG. 5 contains a plurality of cells 8. According to the embodiment shown in FIG. 5, three cells 8 are provided. Each of the cells 8 consists of a first electrode 1 and a second electrode 2. A separating layer 20 is arranged between the first electrode 1 and the second electrode 2. The first electrode 1 comprises the first paste 11. The second electrode 2 comprises the second paste 12. The separating layer 20 is formed by the third paste 32. The separating layer serves to separate the first paste 11 from the second paste 12 but allows electrons to flow or transport ions from the first paste 11 into the second paste 12. The separating layer 20 is also referred to as a separator layer. The separating layer 20 can in particular be porous or contain a porous material. When the cell 8 is immersed in a liquid electrolyte, the separating layer 20 is permeable to the liquid electrolyte. The separating layer 20 can contain a solid electrolyte or consist of a solid electrolyte.

An intermediate layer 44 is arranged between adjacent cells 8. The intermediate layer 44 also enables a flow of electrons from one of the cells 8 to the adjacent cell or cells 8. The intermediate layer 44 can comprise at least one electrically conductive material for allowing an electron flow between two adjacent cells 8.

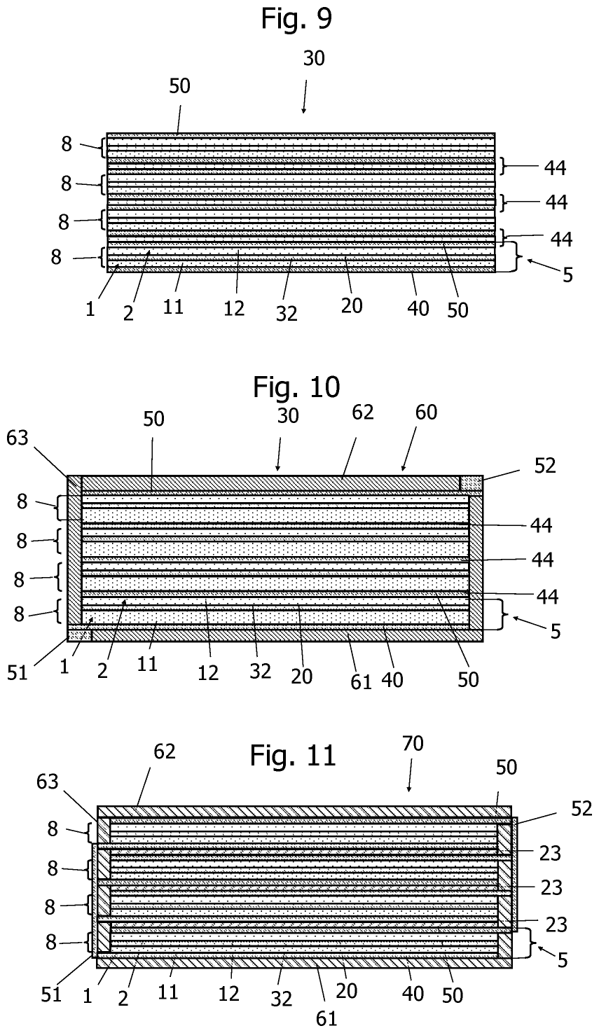

According to FIG. 5, the first electrode 1 of a second and each additional cell 8 is produced in the same way as the first electrode 1 of the cell 8 arranged at the bottom in FIG. 5. Therefore, at this point, reference should be made to the features of the energy store mentioned in the previous embodiments. The cells 8 are connected in series such that a series connection is obtainable. A series connection can be used if the electrical voltage applied to the first and second collectors 40, 50 is to be increased. Alternatively, the intermediate layer 44 can be configured as a multi-layered intermediate layer, which is shown for an example in FIG. 9. The intermediate layer 44 can also consist of a single, electrically conductive layer, which is shown in FIG. 10.

A device 10 for producing an energy store 5 according to FIG. 6 comprises a plurality of modules for producing a cell 8 of the energy store 5. The modules comprise a first electrode module, a second electrode module and a stack module. The cell comprises a first collector 40, a first electrode 1, a second electrode 2, a second collector 50 and a separating layer 20. The separating layer 20 is arranged between the first electrode 1 and the second electrode 2, wherein the first collector 40 is arranged on an opposite side of the first electrode 1 with respect to the separating layer 20, wherein the second collector 50 is arranged on an opposite side of the second electrode 2 with respect to the separating layer 20. The first electrode module comprises a first screen printing device 41 for producing the first electrode 1 and the second electrode module comprises a second screen printing device 42 for producing the second electrode 2.

According to an embodiment, the first screen printing device 41, as shown in in FIG. 2, comprises a first printing pad 3 and a first printing screen 4, which is provided with a first frame 6 containing a first lattice structure 21 for receiving a first paste 11. A first application device 19 is configured to apply the first paste 11 to the first lattice structure 21. If necessary, the first paste 11 is distributed on the first lattice structure 21 by means of a first distribution device 7 belonging to the first screen printing device 41. The first lattice structure 21 is provided with recesses or openings which are configured to be filled with the first paste 11. A first extraction element 18 is provided for extracting the first paste 11 from the openings or recesses in the first lattice structure 21 onto the first printing pad 3. After extraction of the first paste 11 with the first frame 6, the first lattice structure 21 is configured to be separable from the first paste 11 and the first paste 11 can remain on the first printing pad 3.

In particular, the first electrode 1 is configured to be obtained by drying the first paste 11 in a first drying unit 15.

According to an embodiment, as shown schematically in FIG. 3, the second screen printing device 42 comprises a second printing pad 13 and a second printing screen 14, which is provided with a second frame 16 containing a second lattice structure 22 for receiving a second paste 12. In particular, a second application device 29 can be configured to apply the second paste 12 to the second lattice structure 22. If necessary, the second paste 12 can be distributed on the second lattice structure 22 by means of a second distribution device 17 belonging to the second screen printing device 42, wherein the second lattice structure 22 is provided with recesses or openings which are configured to be filled with the second paste 12. A second extraction element 28 can be provided for extracting the second paste 12 from the openings or recesses of the second lattice structure 22 onto the second printing pad 13. After extraction of the second paste 12 with the second frame 16, the second lattice structure 22 is configured to be separable from the second paste 12 and the second paste 12 can remain on the second printing pad 13.

According to an embodiment, the second electrode 2 is obtainable by drying the second paste 12 in a second drying unit 25. In particular, the first paste 11 can differ from the second paste 12.

In particular, the third screen printing device 43 can include a third printing pad 33 and a third printing screen 34, which is provided with a third frame 36 containing a third lattice structure 31 for receiving a third paste 32, wherein at least the third lattice structure 31 is configured to be filled with the third paste 32, to form the separating layer 20, wherein the third paste 32 is applied to the third lattice structure 31 by a third application device 39, wherein the third paste 32 is configured to be distributed on the third lattice structure 31 by means of the third distribution device 37 belonging to the third screen printing device 43.

The third lattice structure 31 is configured to be provided with recesses or openings which are configured to be filled with the third paste 32. A third extraction element 38 can be provided for extracting the third paste 32 from the openings or recesses of the third lattice structure 31 onto the third printing pad 33. After extraction of the third paste 32 with the third frame 36, the third lattice structure 31 can be separable from the third paste 32 and the third paste 32 can remain on the third printing pad 33. In particular, the separating layer is obtainable by drying the third paste 32 in a third drying unit 35.

According to an embodiment, at least one of the first electrodes 1 or the second electrodes 2 can consist of a plurality of layers. In particular, according to an embodiment, the first electrode 1 can have a thickness of 10 μm up to and including 300 μm. In particular, according to an embodiment, the second electrode 2 can have a thickness of 10 μm up to and including 300 μm. In particular, according to an embodiment, the separating layer 20 can have a thickness of 1 μm up to and including 50 μm. In particular, according to an embodiment, the first collector 40 can have a thickness of 1 μm up to and including 50 μm. In particular, according to an embodiment, the second collector 50 can have a thickness of 1 μm up to and including 50 μm.

In particular, according to an embodiment, the first collector 40 can consist of aluminum or an aluminum compound. According to this exemplary embodiment, the first collector 40 is configured as a positive collector. In particular, according to an embodiment, the second collector 50 can be made of copper or a copper compound. According to this exemplary embodiment, the second collector 50 is configured as a negative collector.

In particular, according to an embodiment, the first paste 11 of the first electrode 1 can have a mass fraction of active mass of 50% up to and including 90%, wherein the remaining mass fraction comprises a binding material and/or a solvent and/or a conductive additive.

In particular, according to an embodiment, the second paste 12 of the second electrode 2 can have a mass fraction of active mass of 50% up to and including 90%, wherein the remaining mass fraction comprises a binding material and a conductive additive.

In particular, according to an embodiment, the separating layer 20 can consist of two cover layers made of polypropylene and an intermediate layer made of polyethylene arranged between the two cover layers. According to this embodiment, the thickness of the separating layer 20 can, in particular, amount to 38 μm.

In particular, according to an embodiment, the separating layer 20 can contain an electrolyte which consists of 50 mol % LiPF₆ and 50 mol % of a mixture of ethylene carbonate (EC) and diethyl carbonate (DEC).

In particular, according to an embodiment, the energy store 5 can contain a plurality of cells 8 that are configured as at least one cell stack 9, as shown in FIG. 5. In particular, according to an embodiment, the plurality of cells 8 can be arranged in a parallel connection or in a series connection. An operating voltage of at least 12 V may be available for a series connection.

In particular, according to an embodiment, the cell stack 9 is configured to have at least a first and a second cell 8, wherein an intermediate layer is arranged between the first and second cell 8, wherein the intermediate layer separates the collector for the first electrode of the first cell from the collector for the second electrode of the second cell, so that a total voltage between the first collector 40 and the second collector 50 results from the sum of the cell voltages of the first and second cell 8. In particular, according to an embodiment, the intermediate layer can be electrically conductive, so that a current flow or ion flow can take place from the first cell 8 to the second cell 8.

In particular, according to an embodiment, the cell 8 is configured to contain an electrolyte. In particular, the electrolyte is configured to be contained in the first or second paste 11, 12 or in the separating layer 20 according to an embodiment.

In particular, according to an embodiment, the first or second electrode 1, 2 and the separating layer 20 can be stacked in the cell 8 such that the separating layer 20 is arranged above the first electrode 1 and the second electrode 2 is arranged above the separating layer 20. According to this embodiment, the separating layer 20 lies on the first electrode 1.

In particular, according to an embodiment, the first or second electrode 1, 2 or the separating layer 20 can contain a porous material.

In particular, the first or second collector 40, 50 according to an embodiment can at least partially form a housing. In particular, according to an embodiment, the first or second collector can at least partially be configured as a cooling element.

In particular, according to an embodiment, a plurality of corresponding first or second electrodes 1, 2 or separating layers 20 for a plurality of cells 8 can be arranged next to one another on the first printing pad 3 or the second printing pad 13 or the third printing pad 33.

A method for producing an energy store 5 is described below. The energy store 5 comprises a cell 8, or a plurality of cells 8, wherein the cell 8 comprises a first collector 40, a first electrode 1, a second electrode 2, a second collector 50 and a separating layer 20, wherein the separating layer 20 is arranged between the first electrode 1 and the second electrode 2, wherein the first collector 40 is arranged on a side of the first electrode 1 opposite the separating layer 20, wherein the second collector 50 being arranged on a side of the second electrode 2 opposite the separating layer 20, wherein the first electrode 1 is produced by means of a first screen printing device 41 and the second electrode 2 is produced by means of a second screen printing device 42.

According to an embodiment, the first screen printing device 41 can comprise a first printing pad 3 and a first printing screen 4, which has a first frame 6, which contains a first lattice structure 21 for receiving a first paste 11, wherein the first paste can be applied to the first lattice structure 21 by means of a first application device 19. If necessary, the first paste 11 can be distributed on the first lattice structure 21 by means of a first distribution device 7 belonging to the first screen printing device 41, wherein the first lattice structure 21 is provided with recesses or openings which are filled with the first paste 11. The first paste 11 is removed from the openings or recesses of the first lattice structure 21, in particular by means of a first extraction element 18, and applied to the first printing pad 3, wherein the lattice structure 21 is separated from the paste 11 with the first frame 6 after the first paste 11 has been extracted and the first paste 11 remains on the first printing pad 3. According to an embodiment, the first electrode 1 can be obtained by drying the first paste 11 in a first drying unit 15.

According to an embodiment, the second screen printing device 42 can comprise a second printing pad 13 and a second printing screen 14, which has a second frame 16 that contains a second lattice structure 22 for receiving a second paste 12, wherein the second paste 12 can be applied by means of a second application device 29 to the second lattice structure 22, wherein the second paste 12 is optionally distributed on the second lattice structure 22 by means of a second distribution device 17 belonging to the second screening device 42, wherein the second lattice structure 22 is provided with recesses or openings which are filled with the second paste 12. The second paste 12 can be removed from the openings or recesses of the second lattice structure 22 by means of a second extraction element 28 and applied to the second printing pad 13. After extraction of the second paste 12 with the second frame 16, the second lattice structure 22 can be separated from the second paste 12 and the second paste 12 remains on the second printing pad 13.

According to an embodiment, the second electrode 2 can be obtained by drying the second paste 12 in a second drying unit 25. In particular, the first paste 11 can differ from the second paste 12.

According to an embodiment, the separating layer 20 can be produced by means of a third screen printing device 43. According to an embodiment, the third screen printing device 43 can include a third printing pad 33 and a third printing screen 34, which has a third frame 36 that contains a third lattice structure 31 for receiving a third paste 32, wherein at least the third lattice structure 31 is filled with the third paste 32 to form the separating layer 20. According to an embodiment, the third paste 32 can be applied to the third lattice structure 31 by means of a third application device 39. According to an embodiment, the third paste 32 can be distributed on the third lattice structure 31 by means of the third distribution device 37 belonging to the third screen printing device 43. According to an embodiment, the third lattice structure 31 can be provided with recesses or openings which are filled with the third paste 32. According to an embodiment, the third paste 32 can be removed from the openings or recesses in the third lattice structure 31 by means of a third extraction element 38 and applied to the third printing pad 33. According to an embodiment, the third lattice structure 31 can be separated from the third paste 32 with the third frame 36 after the third paste 32 has been extracted and the third paste 32 can remain on the third printing pad 33.

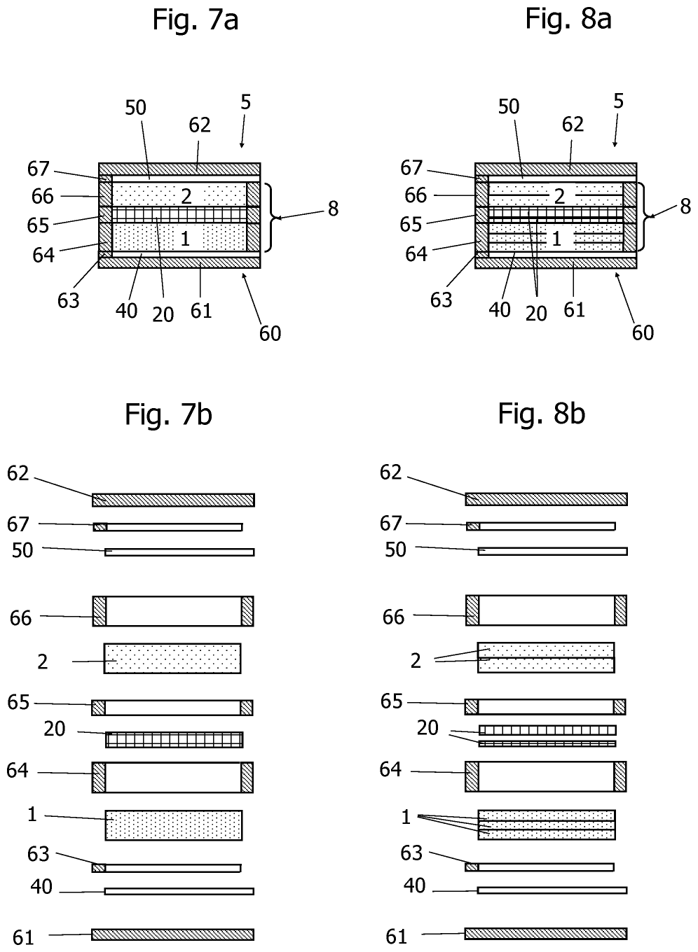

FIG. 7a shows a view of an energy store according to a third embodiment. The energy store comprises a housing 60, a first collector 40, a first electrode 1, a separating layer 20, a second electrode 2, a second collector 50. The housing 60 comprises a housing element, wherein the housing element comprises an element from the group consisting of a housing base 61, a housing lid 62 and at least one housing side element 63, 64, 65, 66, 67, wherein the first collector 40 is arranged on the housing base 61, wherein the first electrode 1 is arranged on the first collector 40, wherein the separating layer 20 is arranged on the first electrode 1, wherein the second electrode 2 is arranged on the separating layer 20, wherein the second collector 50 is arranged on the second electrode 2, wherein the housing lid 62 is arranged on the second collector 50. At least the first electrode 1 is configured as a screen-printed electrode, the separating layer 20 is configured as a screen-printed separating layer and the second electrode 2 is configured as a second screen-printed electrode. The first electrode 1 is surrounded by the housing side element 64. After the first electrode 1 has been produced, the housing side element 64 can be placed on the first electrode and slipped over the first electrode 1. The housing side element 64 surrounds the first electrode 1 to form the periphery of the first electrode 1. In particular, the housing side element 64 can have a ring shape, wherein the ring can have a rectangular or circular shape.

The first collector 40 is disposed adjacent to the housing base 61 and partially disposed within the housing side element 63. The second collector 50 is formed adjacent to the housing lid 62 and is partially arranged inside a housing side element 67. At least one of the first or second collectors 40, 50 may contain a screen-printed collector layer. The housing 60 may include at least one screen-printed housing element. The energy store 5 can contain a liquid electrolyte. At least the separating layer 20 can contain a solid electrolyte. The first electrode 1 and/or the second electrode 2 can contain a solid electrolyte.

FIG. 7b shows an exploded drawing of the individual layers of the energy store 5 shown in FIG. 7a. An exemplary method for producing an energy store 5 is described using the exploded view according to FIG. 7b. The energy store 5 comprises a cell 8, a first collector and a second collector, wherein the cell 8 contains a first electrode 1, a second electrode 2 and a separating layer 20. The separating layer 20 is arranged between the first electrode 1 and the second electrode 2. The first electrode 1 is produced by means of a first screen printing device 41, the second electrode 2 is produced by means of a second screen printing device. The production of the first and second electrodes 1, 2 can take place simultaneously. The first electrode 1 is attached to a first collector 40. The separating layer 20 is applied to the first electrode 1. The second electrode 2 is arranged on the separating layer 20 and the second collector 50 is arranged on the second electrode 2.

The separating layer 20 can be produced by means of a third screen printing device 43. The first collector 40 can be produced by means of a first collector screen printing device. The second collector 50 can be produced by means of a second collector screen printing device. A first electrode module can be provided, which contains the first screen printing device 41, optionally a first drying unit 15 and a first stacking device, by means of which the first electrode is screen printed, optionally dried, and placed on the first collector 40.

A second electrode module can be provided, which contains the second screen printing device 42 and optionally a second drying unit 25, by means of which the second electrode 2 is screen printed and optionally dried. A separating layer module can be provided which contains the third screen printing device 43, optionally a third drying unit 35 and a third stacking device, by means of which the separating layer 20 is screen printed, optionally dried, and deposited on the first electrode 1. The second electrode module can contain a second stacking device, by means of which the screen-printed and optionally dried second electrode 2 and is deposited on the separating layer 20.

A first collector module can be provided, which contains the first collector screen printing device, optionally a first collector drying unit and a first collector stacking device, by means of which the first collector 40 is screen-printed, optionally dried, and placed on a housing element. A second collector module can be provided, which contains the second collector screen printing device, optionally a second collector drying unit and a second collector stacking device, by means of which the second collector is screen-printed, optionally dried, and placed on the second electrode 2. A housing element module can be provided which contains a housing element screen printing device, by means of which at least one housing element is screen printed. The housing element module may include a housing element drying device. The housing element module may include a housing element module stacking device.

FIG. 8a shows a view of an energy store according to a fourth embodiment. The energy store comprises a housing 60, a first collector 40, a first electrode 1, a separating layer 20, a second electrode 2, a second collector 50. The housing 60 comprises a housing element, wherein the housing element comprises an element from the group consisting of a housing base 61, a housing lid 62 and at least one housing side element 63, 64, 65, 66, 67, wherein the first collector 40 is arranged on the housing base 61, wherein the first electrode 1 is arranged on the first collector 40, wherein the separating layer 20 is arranged on the first electrode 1, wherein the second electrode 2 is arranged on the separating layer 20, wherein the second collector 50 is arranged on the second electrode 2, wherein the housing lid 62 is arranged on the second collector 50.

According to this embodiment, the first electrode 1 consists of a plurality of electrode sub-layers. Three electrode sub-layers are shown as an example, but two or more than three electrode sub-layers could also be provided. At least one of the electrode sub-layers, which form the first electrode 1, is configured as a screen-printed electrode sub-layer. The first electrode 1 is surrounded by the housing side element 64. After the first electrode 1 has been produced, the housing side element 64 can be placed on the first electrode and slipped over the first electrode 1. The housing side element 64 surrounds the first electrode 1 to form the periphery of the first electrode 1. In particular, the first housing side element 64 can have a ring shape, wherein the ring may have a rectangular or circular shape.

According to this embodiment, the separating layer 20 consists of a plurality of separating sub-layers. Two separating sub-layers are shown as an example, but three or more than three separating sub-layers could also be provided. The composition of each of the separating sub-layers may differ. The thickness of each of the separating sub-layers may differ from the thickness of another separating sub-layer. At least one of the separating sub-layers forming the separating layer 20 is configured as a screen-printed separating sub-layer. The housing side element 65 can be placed on the separating layer 20 after the production of the separating layer 20 and slipped over the separating layer 20. The housing side element 65 surrounds the separating layer 20 to form the perimeter of the separating layer 20. In particular, the housing side element 65 can have a ring shape, wherein the ring may have a rectangular or round shape.

According to this embodiment, the second electrode 2 consists of a plurality of electrode sub-layers. Two electrode sub-layers are shown as an example, but three or more than three electrode sub-layers could also be provided. At least one of the electrode sub-layers, which forms the second electrode 2, is configured as a second screen-printed electrode. After the second electrode 2 has been produced, the housing side element 66 can be placed on the second electrode 2 and slipped over the second electrode 2. The housing side element 66 surrounds the second electrode 2 to form the periphery of the second electrode 2. In particular, the housing side element 66 may have a ring shape, wherein the ring can have a rectangular or circular shape. An associated housing side element sub-layer can also be produced separately for each of the electrode sub-layers, which is not shown in the drawing.

The first collector 40 is disposed adjacently to the housing base 61 and partially arranged within the housing side element 63. The second collector 50 is disposed adjacent to the housing lid 62 and is partially arranged inside a housing side element 67.

At least one of the first or second electrodes 1, 2 can contain a first screen-printed electrode sub-layer, the composition of which differs from a second screen-printed electrode sub-layer. At least one of the first or second collectors 40, 50 may contain a screen-printed collector layer. The housing 60 can include at least one screen-printed housing element. The energy store 5 can contain a liquid electrolyte. At least the separating layer 20 can contain a solid electrolyte. The first electrode 1 and/or the second electrode 2 can contain a solid electrolyte.

FIG. 8b shows an exploded view of the individual layers of the energy store 5 shown in FIG. 8a. An exemplary method for producing an energy store 5 is described using the exploded view according to FIG. 8b. The energy store 5 comprises a cell 8, a first collector and a second collector, wherein the cell 8 contains a first electrode 1, a second electrode 2 and a separating layer 20. The separating layer 20 is arranged between the first electrode 1 and the second electrode 2. The first electrode 1 is produced by means of a first screen printing device 41, the second electrode 2 is produced by means of a second screen printing device. The production of the first and second electrodes 1, 2 can take place simultaneously. Each of the electrode sub-layers of the first electrode 1 can be produced sequentially by means of the first screen printing device 41. Each of the electrode sub-layers of the second electrode 2 can be produced sequentially by means of the second screen printing device 42. The first electrode 1 is attached to a first collector 40. The separating layer 20 is applied to the first electrode 1. The second electrode 2 is attached to the separating layer 20 and the second collector 50 is attached to the second electrode 2.

The separating layer 20 can be produced by means of a third screen printing device 43. Each of the separating sub-layers of the separating layer 20 can be produced sequentially by means of the third screen printing device 43. The first collector 40 can be produced by means of a first collector screen printing device. The second collector 50 can be produced by means of a second collector screen printing device. A first electrode module can be provided, which contains the first screen printing device 41, optionally a first drying unit 15 and a first stacking device, by means of which the first electrode 1 is screen printed, optionally dried and placed on the first collector 40.

A second electrode module can be provided, which contains the second screen printing device 42 and optionally a second drying unit 25, by means of which the second electrode 2 is screen printed and optionally dried. A separating layer module can be provided which contains the third screen printing device 43, optionally a third drying unit 35 and a third stacking device, by means of which the separating layer 20 is screen printed, optionally dried and deposited on the first electrode 1. The second electrode module can contain a second stacking device, by means of which the screen-printed and optionally dried second electrode 2 is deposited on the separating layer 20.

A first collector module can be provided, which contains the first collector screen printing device, optionally a first collector drying unit and a first collector stacking device, by means of which the first collector 40 is screen-printed, optionally dried and placed on a housing element. A second collector module can be provided, which contains the second collector screen printing device, optionally a second collector drying unit and a second collector stacking device, by means of which the second collector is screen-printed, optionally dried and placed on the second electrode 2. A housing element module can be provided which contains a housing element screen printing device, by means of which at least one housing element is screen printed. The housing element module can include a housing element drying device. The housing element module can include a housing element stacking device.

FIG. 9 shows a schematic view of an energy store module 30. The energy store module 30 comprises a plurality of energy stores 5. The energy stores 5 of the energy store module 30 are arranged in series with one another. For example, in FIG. 9, four energy stores 5, each containing a cell 8, are thus arranged one above the other. Only one of the energy stores 5, namely the energy store 5 located at the bottom in the drawing, is indicated in FIG. 9. Each of the energy stores 5 consists of a first collector 40, a first electrode 1 arranged above the first collector, a separating layer 20 arranged on the first electrode 1, a second electrode 2 arranged on the separating layer 20 and a second collector 50 arranged on the second electrode 2.

According to this embodiment, the intermediate layer 44 contains three electrically conductive layers, a first conductive layer for connection to the second electrode 2, a second conductive middle layer for connection of the first conductive layer to a third conductive layer, which in turn is connected to the first electrode 1 there above. With regard to the concept of the energy store 5 introduced earlier, the intermediate layer 44 thus forms its second collector. In other words, the energy store module according to FIG. 9 consists of four cells 8 and three intermediate layers 44 and a first collector 40, which forms the bottom layer, and a second collector 50, which forms the top layer. The energy store module is usually accommodated in a housing, which is omitted from this illustration. Any contacts of the first and second collectors, which enable a current to flow in an electric circuit containing at least one consumer, are also omitted in this illustration for the sake of simplicity.

The number of energy stores 5 can be chosen to be as large as desired, wherein the energy stores 5 of the energy store module 30 are arranged in a series connection with one another. Such a series connection of energy stores 5 can advantageously be used when a larger voltage is required.

FIG. 10 shows a schematic view of an accumulator containing an energy store module 30. The energy store module 30 comprises a plurality of energy stores 5. The energy stores 5 of the energy store module 30 are arranged in series with one another. As in FIG. 9, four energy stores 5, each containing a cell 8, are arranged one above the other. Each of the energy stores 5 consists of a first collector 40, a first electrode 1 arranged thereupon, a separating layer 20 arranged on the first electrode 1, a second electrode 2 arranged on the separating layer 20 and a second collector 50 arranged on the second electrode 2.

The intermediate layer 44 according to this exemplary embodiment consists of a single, electrically conductive layer. In other words, the energy store module according to FIG. 10 consists of four cells 8 and three intermediate layers 44 and a first collector 40, which forms the bottom layer, and a second collector 50, which forms the top layer. The energy store module 30 is accommodated in a housing 60. The housing 60 comprises a housing base 61, a housing lid 62 and at least one housing side element 63. A first contact 51 is also shown, which is configured to receive current from the first collector 40. A second contact 51, which is configured to receive current from the second collector 50, is also shown. The direction of the current flow depends on whether the first electrode is a positive or a negative electrode. Therefore, depending on the type of electrode, the first contact 51 can be in the form of a positive pole or a negative pole. The second contact 52 accordingly forms the opposite pole. The first and second contacts 51, 52 can be arranged on opposite sides of the housing 60, they can also be formed on the same side of the housing 60 according to the embodiments shown in FIG. 7a or FIG. 8a.

FIG. 11 shows a schematic view of an accumulator containing an energy store module 70. The energy store module 70 comprises a plurality of energy stores 5. The energy stores 5 of the energy store module 70 are arranged parallel to one another. As in FIG. 9, four energy stores 5, each containing a cell 8, are arranged one above the other. Each of the energy stores 5 consists of a first collector 40, a first electrode 1 arranged thereupon, a separating layer 20 arranged on the first electrode 1, a second electrode 2 arranged on the separating layer 20 and a second collector 50 arranged on the second electrode 2. As described in the previous embodiments, each of the first electrodes 1, second electrodes 2 or the separating layers 20 can contain a plurality of sub-layers.

Adjacent energy stores 5 are separated from one another by an insulation layer 23. The insulation layer 23 according to this embodiment consists of a single, electrically non-conductive layer. In other words, the energy store module according to FIG. 10 consists of four energy stores 5 and three insulation layers, wherein each of the energy stores 5 has a cell 8, a first collector 40, which forms the bottom layer, and a second collector 50, which forms the top layer of the energy store 5. The energy store module 70 is accommodated in a housing 60. The housing 60 comprises a housing base 61, a housing lid 62 and at least one housing side element 63. A first contact 51 is also shown, which is configured to receive current from the first collector 40. A second contact 51, which is configured to receive current from the second collector 50, is also shown. The direction of the current flow depends on whether the first electrode is a positive or a negative electrode. Therefore, depending on the type of electrode, the first contact 51 can be in the form of a positive pole or a negative pole. The second contact 52 accordingly forms the opposite pole. The first and second contacts 51, 52 can be arranged on opposite sides of the housing 60, they can also be configured to be arranged on the same side of the housing 60 according to the embodiments shown in FIG. 7a or FIG. 8a.

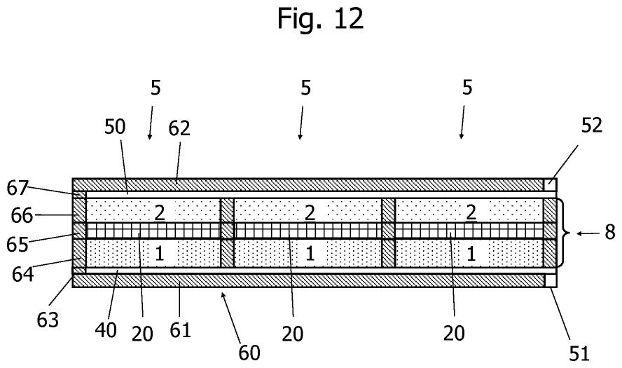

FIG. 12 shows a view of an accumulator containing a plurality of energy stores 5 according to a third embodiment in a parallel arrangement. Each of the energy stores 5 comprises a housing 60, a first collector 40, a first electrode 1, a separating layer 20, a second electrode 2, a second collector 50. The housing 60 comprises a housing element, wherein the housing element comprises an element from the group consisting of a housing base 61, a housing lid 62 and at least one housing side element 63, 64, 65, 66, 67, wherein the first collector 40 is arranged on the housing base 61, wherein the first electrode 1 is arranged on the first collector 40, wherein the separating layer 20 is arranged on the first electrode 1, wherein the second electrode 2 is arranged on the separating layer 20, wherein the second collector 50 is arranged on the second electrode 2, wherein the housing lid 62 is arranged on the second collector 50.

At least the first electrode 1 is configured as a screen-printed electrode, the separating layer is configured as a screen-printed separating layer and the second electrode 2 is configured as a second screen-printed electrode. The first electrode 1 is surrounded by the case side member 64. After the first electrode 1 has been produced, the housing side element 64 can be placed on the first electrode and slipped over the first electrode 1. The housing side element 64 surrounds the first electrode 1 to form the periphery of the first electrode 1. In particular, the housing side element 64 can have a ring shape, wherein the ring can have a rectangular or circular shape. The housing side element 65 can be placed on the separating layer 20 after the production of the separating layer 20 and slipped over the separating layer 20. The housing side element 65 surrounds the separating layer 20 to form the perimeter of the separating layer 20. In particular, the housing side element 65 can have a ring shape, wherein the ring can have a rectangular or circular shape. After the second electrode 2 has been produced, the housing side element 66 can be placed on the second electrode 2 and slipped over the second electrode 2. The housing side element 66 surrounds the second electrode 2 to form the periphery of the second electrode 2. In particular, the housing side element 66 can have a ring shape, where the ring can have a rectangular or circular shape.

The first collector 40 is disposed adjacent to the housing base 61 and partially disposed within the housing side element 63. The second collector 50 is formed adjacent to the housing lid 62 and is partially arranged inside a housing side element 67. At least one of the first or second collectors 40, 50 can contain a screen-printed collector layer. A first contact 51 is provided for current collection from the first collector 40. A second contact 51 is configured to receive current from the second collector 50. The housing 60 can include at least one screen-printed housing element. Each of the energy stores 5 can contain a liquid electrolyte. At least the separating layer 20 can contain a solid electrolyte. The first electrode 1 and/or the second electrode 2 can contain a solid electrolyte.

### Example

A lithium-ion cell with the following structure was used to determine the energy density. The cell consists of a copper negative collector, an anode layer arranged thereon, a separating layer, a cathode layer disposed on the separating layer, and an aluminum layer disposed on the cathode layer. The collector made of copper has a thickness of 20 μm. The anode layer consists of 85% by weight active mass, 5% binder material and 10% of a conductive additive. The porosity of the anode layer is 30%. The active mass consists of graphite. The binding material consists of PVDF. The conductive additive consists of Super C65 conductive carbon black with a BET surface area of 62 m²/g, an ash content of 0.01% maximum and an iron content of 2 ppm maximum.

The separating layer has a thickness of 38 μm. The separating layer contains an electrolyte consisting of 1 mol LiPF6 and a 1:1 mixture of ethylene carbonate/diethyl carbonate.

It is obvious to a person skilled in the art that many other variants are possible in addition to the exemplary embodiments described, without departing from the inventive concept. The subject of the invention is thus not limited by the foregoing description and is to be determined by the scope of protection defined by the claims. For the interpretation of the claims or the description, the broadest possible reading of the claims is decisive. In particular, the terms “comprise” or “include” shall be construed as referring to elements, components, or steps in a non-exclusive sense, thereby indicating that the elements, components or steps may be present or used that they can be combined with other elements, components or steps that are not explicitly mentioned. When the claims relate to an element or component from a group that may consist of A, B, C to N elements or components, this language should be interpreted as requiring only a single element of that group, and not one combination of A and N, B and N or any other combination of two or more elements or components of this group.

1. A device for producing an energy store comprising a plurality of modules, the plurality of modules comprising a first electrode module, a second electrode module and a stack module, wherein the energy store comprises a cell, wherein the cell comprises a first electrode, a second electrode, and a separating layer, wherein the separating layer is arranged between the first electrode and the second electrode, wherein the first electrode module comprises a first screen printing device for producing the first electrode and the second electrode module comprises a second screen printing device for producing the second electrode.

2. The device of claim 1, wherein the device contains a separating layer module, wherein the separating layer module contains a third screen printing device for producing the separating layer.

3. The device of claim 1, wherein the energy store contains at least one of a first collector and a second collector, wherein the first collector is arranged on an opposite side of the first electrode with respect to the separating layer, wherein the second collector is arranged on an opposite side of the second electrode with respect to the separating layer.

4. (canceled)

5. The device of claim 1, wherein the first screen printing device comprises a first printing pad and a first printing screen, which has a first frame comprising a first lattice structure for receiving a first paste, wherein a first application device is configured for applying the first paste to the first lattice structure, wherein the first lattice structure has recesses or openings which are configured to be filled with the first paste, wherein a first extraction element is provided for extracting the first paste from the openings or recesses in the first lattice structure onto the first printing pad, wherein the first lattice structure can be separated from the first paste after extraction the first paste with the first frame and the first paste remains on the first printing pad, wherein the first electrode is obtainable by drying the first paste in a first drying unit.

6. The device of claim 1, wherein the second screen printing device comprises a second printing pad and a second printing screen, which has a second frame comprising a second lattice structure for receiving a second paste, wherein a second application device is configured for applying the second paste to the second lattice structure, wherein optionally by means of a second distribution device belonging to the second screen printing device, the second paste is distributed on the second lattice structure, wherein the second lattice structure has recesses or openings which can be filled with the second paste, wherein a second extraction element for extracting the second paste is provided from the openings or recesses of the second lattice structure on the second printing pad, wherein the second lattice structure can be separated after extraction of the second paste from the second paste with the frame and the second paste remains on the second printing pad, wherein the second electrode can be obtained by drying the second paste in a second drying unit.

7. The device of claim 1, comprising a third screen printing device for producing the separating layer, wherein the third screen printing device comprises a third printing pad and a third printing screen which has a third frame which contains a third lattice structure for receiving a third paste, wherein at least the third lattice structure is configured to be filled with the third paste in order to form the separating layer, wherein the third paste is configured to be applied by a third application device to the third lattice structure, wherein a third distribution device belonging to the third screen printing device is configured to distribute the third paste on the third lattice structure, wherein the third lattice structure has recesses or openings which can be filled with the third paste, wherein a third extraction element for extracting the third paste from the openings or recesses of the third lattice structure onto the third printing pad is provided, wherein the third lattice structure is separable after extraction of the third paste with the third frame from the third paste and the third paste remains on the third printing pad, wherein the separating layer can be obtainable by drying the third paste in a third drying unit.

8. The device of claim 1, wherein at least one of the first electrodes or the second electrodes consists of a plurality of layers.

9. The device of claim 1, wherein at least one of the first electrode and the second electrode has a thickness of 1 μm up to and including 300 μm.

10. The device of claim 1, wherein the energy store contains a plurality of cells which form at least one cell stack, wherein the cell stack can be provided with least a first and a second cell, wherein an intermediate layer can be arranged between the first and second cells, wherein the intermediate layer separates a first collector for the first electrode of the first cell from a second collector for the second electrode of the second cell, so that a total voltage between the first collector and the second collector results from a sum of the cell voltages of the first and second cell.

11. (canceled)

12. The device of claim 1, wherein the first or second electrode or the separating layer contains a porous material.

13. The device of claim 1, wherein a plurality of corresponding first or second electrodes or separating layers for a plurality of cells are arranged side by side on a first printing pad or on a second printing pad or on a third printing pad.

14. An energy store comprising a housing, a first collector, a first electrode, a separating layer, a second electrode, a second collector, wherein the housing comprises a housing element, wherein the housing element comprises an element from the group consisting of a housing base, a housing lid and at least one housing side element, wherein the first collector is arranged on the housing base, wherein the first electrode is arranged on the first collector, wherein the separating layer is arranged on the first electrode, wherein the second electrode is arranged on the separating layer, wherein the second collector is arranged on the second electrode, wherein the housing lid is arranged on the second collector, characterized in that at least the first electrode is configured as a screen-printed electrode, the separating layer is configured as a screen-printed separating layer and the second electrode is configured as a second screen-printed electrode, wherein the first collector is arranged next to the housing base and is arranged partially within the at least one housing side element, wherein the second collector is arranged adjacently to the housing lid and partially within the at least one housing side element.

15. The energy store of claim 14, wherein at least one of the first or second electrodes contains a plurality of screen-printed electrode sub-layers, wherein a composition of the first screen-printed electrode sub-layer can differ from the composition of a second screen-printed electrode sub-layer.

16. (canceled)

17. The energy store of claim 14, wherein at least one of the first or second collectors or the housing contains a screen-printed collector layer or at least one screen printed housing element.

18. (canceled)

19. The energy store of claim 14, wherein the housing contains a liquid electrolyte or at least the separating layer contains a solid electrolyte.

20. A method for producing an energy store, wherein the energy store comprises a cell, a first collector and a second collector, wherein the cell has a first electrode, a second electrode and a separating layer, wherein the separating layer is arranged between the first electrode and the second electrode, wherein the first electrode is produced by means of a first screen printing device, wherein the second electrode is produced by means of a second screen printing device, wherein the first electrode is placed on a first collector, wherein the separating layer is applied on the first electrode, wherein the second electrode is applied on the separating layer and wherein the second collector is placed on the second electrode, wherein the separating layer can be produced by means of a third screen printing device and wherein at least one of the first collector and the second collector can be produced by means of a first collector screen printing device or a second collector screen printing device.

21. (canceled)

22. (canceled)

23. (canceled)

24. The method of claim 20, wherein at least one of a first electrode module, a second electrode module, a separating layer module, a first collector module and a second collector module is provided, wherein the first electrode module contains the first screen printing device, optionally a first drying unit and a first stacking device, by means of which the first electrode is screen printed, optionally dried and placed on the first collector, wherein the second electrode module contains the second screen printing device, optionally a second drying unit, by means of which the second electrode is screen printed, and optionally dried, wherein the separating layer module contains the third screen printing device, optionally a third drying unit and a third stacking device, by means of which the separating layer is screen printed, optionally dried, and placed on the first electrode, wherein the first collector module contains the first collector screen printing device, optionally a first collector drying unit and a first collector stacking device, by means of which the first collector is screen-printed, optionally dried and placed on a housing element, wherein the second collector module contains the second collector screen printing device, optionally a second collector drying unit and a second collector stacking device, by means of which the second collector is screen-printed, optionally dried and placed on the second electrode.

25. (canceled)

26. (canceled)

27. The method of claim 24, wherein the second electrode module contains a second stacking device, by means of which the screen-printed and optionally dried second electrode is placed on the separating layer.

28. (canceled)

29. (canceled)

30. The method of claim 20 wherein a housing element module is provided which contains a housing element screen printing device, by means of which at least one housing element is screen printed, wherein the housing element module can include at least one of a housing element drying device or a housing element stacking device.

31. (canceled)

32. (canceled)

33. The method of claim 20, wherein at least one of the first electrodes, the second electrodes or the separating layers is compressed after drying.
